(19) United States
(12) Patent Application Publication
(10) Pub. No.: US 2014/0106065 A1
(43) Pub. Date: Apr. 17, 2014

(54) MANUFACTURING METHOD OF MAGNETIC RECORDING MEDIUM

(71) Applicant: KABUSHIKI KAISHA TOSHIBA, Tokyo (JP)

(72) Inventors: Tomoyuki MAEDA, Kawasaki-shi (JP); Hiroyuki HIEDA, Yokohama-shi (JP); Masahiro KANAMARU, Kawasaki-shi (JP); Katsuya SUGAWARA, Kawasaki-shi (JP)

(21) Appl. No.: 13/930,288

(22) Filed: Jun. 28, 2013

(30) Foreign Application Priority Data
Oct. 12, 2012 (JP) 2012-227161

(51) Int. Cl. G11B 5/84

(52) U.S. Cl. CPC G11B 5/8408
USPC 427/130; 204/192.2

(57) ABSTRACT

A method for manufacturing a patterned medium of an embodiment includes forming a perpendicular magnetic recording layer on a substrate, forming a mask on the perpendicular magnetic recording layer, milling the perpendicular magnetic recording layer, and depositing a protective layer on the perpendicular magnetic recording layer. The perpendicular magnetic recording layer includes a first element selected from Fe and Co and a second element selected from Pt and Pd, and has a hard magnetic alloy material having an L1₀ or L1₁ structure. A temperature of the substrate during the milling is higher than or equal to 250° C. and lower than or equal to 500° C.

### CROSS REFERENCE TO RELATED APPLICATION

This application is based upon and claims the benefit of priority from Japanese Patent Application No. 2012-227161, filed on Oct. 12, 2012; the entire contents of which are incorporated herein by reference.

### FIELD

Embodiments described herein relate generally to a manufacturing method of a magnetic recording medium.

### BACKGROUND

Increase in recording density of magnetic recording devices (HDD) which record and reproduce information is demanded. To increase storage density, utilization of a perpendicular magnetic recording method as a magnetic recording method for HDD instead of an in-plane magnetic recording method is becoming popular. In the perpendicular magnetic recording method, magnetic crystal grains in a magnetic recording layer on a substrate have an easy magnetization axis perpendicular to the substrate.

Here, a patterned medium having plural magnetic dots is considered. In the patterned medium, the plural magnetic dots having gaps are made by finely processing a perpendicular magnetic recording layer. With the gaps, the magnetic dots can be magnetically isolated and stabilized.

At this moment, accompanying increase in recording density, miniaturization of the magnetic dots becomes necessary. Thus, it is necessary to increase magnetic anisotropy energy density (Ku) of the magnetic material in order to maintain thermal fluctuation resistance of recording magnetization.

For finely processing the perpendicular magnetic recording layer when making the patterned medium, ion milling using inert gas ions of Ar or the like is generally used. However, it is possible that the characteristics (for example, the magnetic anisotropy energy density (Ku)) of the magnetic material decrease by the ion milling.

### BRIEF DESCRIPTION OF THE DRAWINGS

FIG. 1 is a cross-sectional view representing a patterned medium 10 according to a first embodiment.

FIG. 2 is a flowchart representing manufacturing steps of the patterned medium 10.

FIGS. 3A-3E are cross-sectional views representing the patterned medium 10 being manufactured.

FIG. 4 is a cross-sectional view representing a patterned medium 10a according to Modification Example 1.

FIG. 5 is a cross-sectional view representing a patterned medium 10b according to Modification Example 2.

FIG. 6 is a cross-sectional view representing a patterned medium 10c according to Modification Example 3.

FIG. 7 is a flowchart representing manufacturing steps of the patterned media 10a to 10c.

FIG. 8 is a view representing a magnetic recording and reproducing device according to a second embodiment.

FIG. 9 is a diagram illustrating an evaluation method of a coercive force dispersion width ΔHc.

### DETAILED DESCRIPTION

A method for manufacturing a patterned medium of an embodiment includes forming a perpendicular magnetic recording layer on a substrate, forming a mask on the perpendicular magnetic recording layer, milling the perpendicular magnetic recording layer, and depositing a protective layer on the perpendicular magnetic recording layer. The perpendicular magnetic recording layer includes a first element selected from Fe and Co and a second element selected from Pt and Pd, and has a hard magnetic alloy material having an L1₀ or L1₁ structure. A temperature of the substrate during the milling is higher than or equal to 250° C. and lower than or equal to 500° C.

Hereinafter, embodiments will be described in detail with reference to the drawings.

### First Embodiment

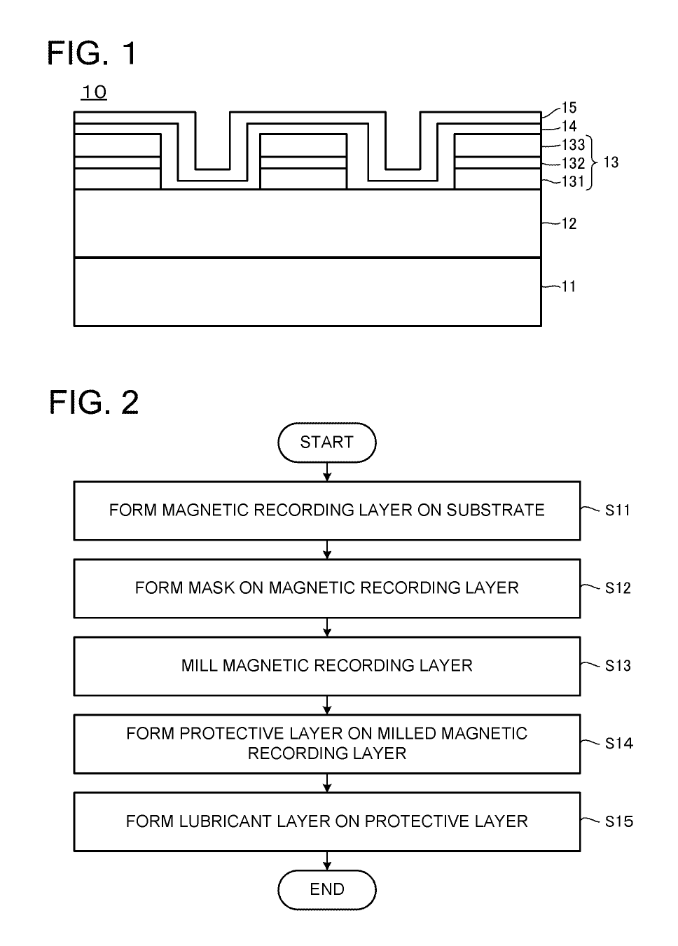

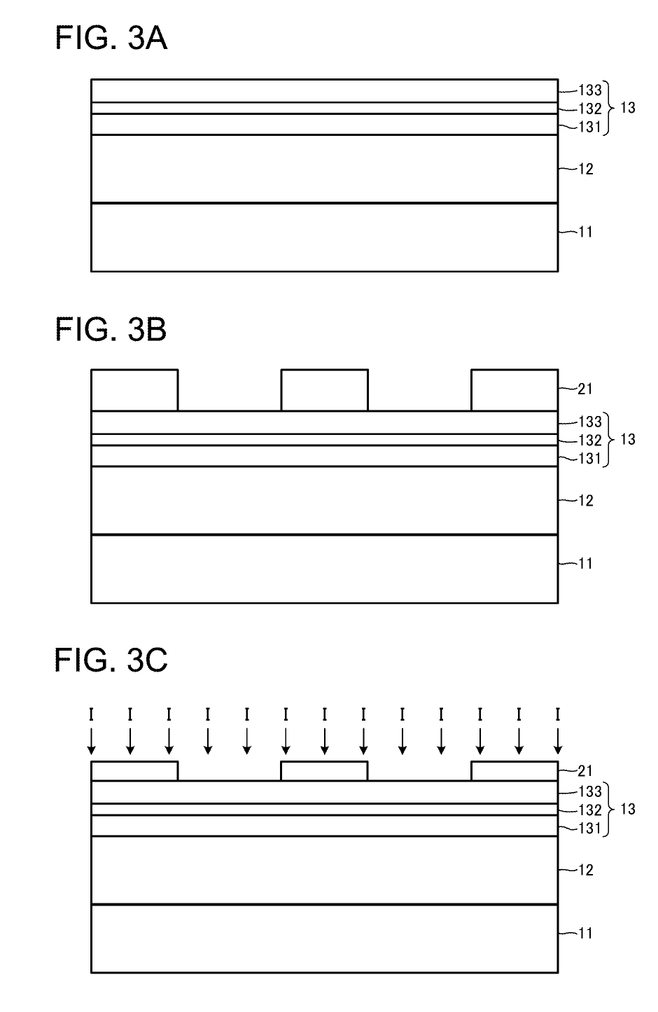

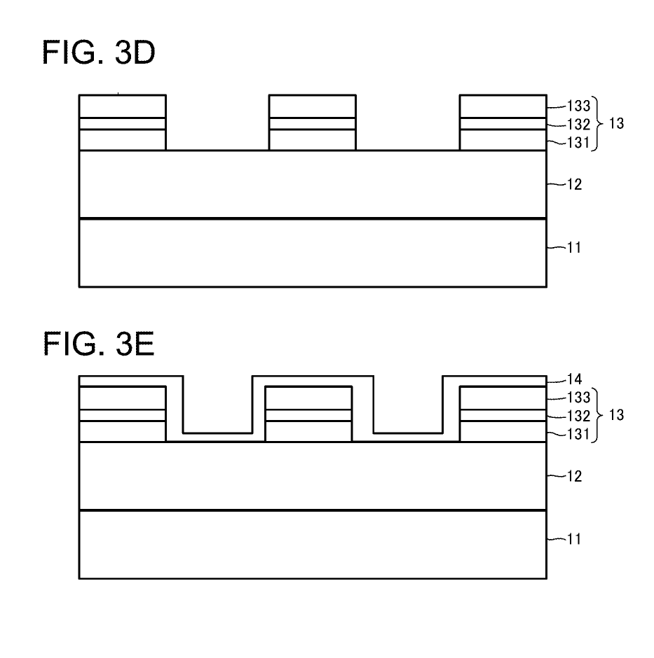

FIG. 1 is a cross-sectional view representing a patterned medium 10 according to a first embodiment. FIG. 2 is a flowchart representing a making procedure for the patterned medium 10. FIG. 3A to FIG. 3E are cross-sectional views representing the patterned medium 10 being made.

In the patterned medium 10, a non-magnetic base layer 12, a perpendicular magnetic recording layer 13, a protective layer 14, and a lubricant layer 15 are stacked sequentially on a substrate 11.

### (1) Formation of the Perpendicular Magnetic Recording Layer 13 on the Substrate 11 (Step S11, see FIG. 3A)

The perpendicular magnetic recording layer 13 is formed on the substrate 11. Note that, as will be described later, the non-magnetic base layer 12 is formed as necessary.

As a material for the substrate 11, a non-magnetic material such as glass, Al-based alloy, Si monocrystal with an oxidized surface, ceramics, and plastic can be used. Plating of NiP alloy or the like may be performed on the surface of these non-magnetic materials.

In the perpendicular magnetic recording layer 13, a hard magnetic recording layer 131, a non-magnetic intermediate layer 132, and a soft magnetic recording layer 133 are stacked sequentially.

The perpendicular magnetic recording layer 13 functions as what is called an ECC (Exchange Coupled Composite) medium. By forming the perpendicular magnetic recording layer 13 from the hard magnetic recording layer 131, the non-magnetic intermediate layer 132, and the soft magnetic recording layer 133 which are stacked sequentially, switching field dispersion SFD can be reduced. In the ECC medium, the hard magnetic recording layer 131 responsible for retaining recording magnetization and the soft magnetic recording layer 133 which facilitates magnetization reversal are exchange coupled via the non-magnetic intermediate layer 132 which is thin.

The hard magnetic recording layer 131 is formed of hard magnetic crystal grains having an easy magnetization axis directed in a stacking direction of the hard magnetic recording layer 131 (direction perpendicular to the substrate 11). The material of the hard magnetic crystal grains is preferred to have moderate coercive force H_{c} and high magnetic anisotropy energy density Ku. The moderate coercive force H_{c} is for suppressing occurrence of a reverse magnetic domain with respect to an external magnetic field, a floating magnetic field, and the like. The high magnetic anisotropy energy density Ku is for obtaining sufficient thermal fluctuation resistance.

As the hard magnetic crystal material, one having an L1₀ structure and containing magnetic metal elements and rare metal elements as main components is used preferably. The magnetic metal is at least one type selected from Fe and Co, and the rare metal element is at least one type selected from the group constituted of Pt and Pd. Specifically, it is possible to use an Fe—Pt alloy, Co—Pt alloy, and Fe—Pd alloy in which an atomicity ratio of magnetic elements:rare metal elements is in the range of 4:6 to 6:4. These materials have quite high magnetic anisotropy energy density Ku of 10⁷ erg/cc or higher when they have the L1₀ structure (or an L1₁ structure which will be described later) (when they become an ordered alloy) in a c-axis direction and excels in thermal fluctuation resistance.

For the purpose of improving magnetic characteristics or electromagnetic conversion characteristics, an appropriate amount of elements, such as Cu, Zn, Zr, Cr, Ru, and/or Ir, may be added into the hard magnetic recording layer 131.

Whether crystal grains forming the hard magnetic recording layer 131 have the L1₀ structure or not can be confirmed with a general X-ray diffractometer. When a peak (superlattice reflection) representing a plane ((001), (003) plane, or the like) which cannot be observed on a disordered face-centered cubic lattice (FCC) can be observed with a diffraction angle that matches each spacing, it can be said that the L1₀ structure exists.

As an index for estimating whether the hard magnetic crystal grains assume a structure close to the complete L1₀ structure, a degree of order S can be used in general. When the “degree of order S=1”, it means a complete L1₀ structure, and when the “degree of order S=0”, it means a complete disordered structure. In the case of the above-described alloys, generally, as the degree of order S becomes higher, the magnetic anisotropy energy density Ku becomes higher, which is preferable. The degree of order S can be estimated with the following equation using the integrated intensity of the peak of each (001), (002) plane obtained by X-ray diffraction measurement.

S=0.72·(I₀₀₁/I₀₀₂)^{1/2}

Here, each of I₀₀₁, I₀₀₂ is the integrated intensity of a diffraction peak by the (001), (002) plane. In the patterned medium, when the degree of order S is higher than 0.6, it can be said that it has the L1₀ structure.

Further, whether the hard magnetic crystal material is (001) plane oriented (c-axis oriented) can be confirmed by a general X-ray diffractometer.

As the hard magnetic crystal material, it is possible to use the material having an L1₁ structure formed of the same elements and composition, besides these materials of the L1_{c} structure. Crystal grains of the L1₁ structure can be formed when the non-magnetic base layer 12 formed of a material having an hcp (hexagonal close-packed) structure, such as Ru, Re for example, is provided.

The above-described hard magnetic material, when deposited at room temperature, tends to form a disordered phase which is a metastable phase. Thus, it is necessary to form an ordered phase which is a stable phase by causing dispersion of alloy atoms by heating the substrate 11 during deposition.

Temperatures of the substrate 11 at this time are preferred to be in the range of 250° C. to 500° C. because this improves the degree of order S of the hard magnetic crystal material. The temperatures are more preferred to be in the range of 300° C. to 400° C. When the temperatures of the substrate 11 are lower than 250° C., the dispersion of alloy atoms is difficult to occur and the ordered phase is difficult to be formed, and hence they are not preferable. On the other hand, when the temperatures of the substrate 11 are over 500° C., flatness of the perpendicular magnetic recording layer 13 deteriorates and formation of a milling mask 21 is difficult in step S12, and hence they are not preferable.

Further, when the above-described hard magnetic material is deposited by a sputtering method, when the pressure of rare gas such as Ar (sputtering gas) is in the range of 4 Pa to 12 Pa, the degree of order S improves, which is preferable. The pressure of the sputtering gas being in the range of 6 Pa to 10 Pa is further preferable.

The non-magnetic intermediate layer 132 is disposed between the hard magnetic recording layer 131 and the soft magnetic recording layer 133, and has a function to moderately weaken the exchange coupling force between the both layers to make them become an ECC medium. Thus, in addition to further reduction of the switching field, it is possible to reduce the switching field dispersion (SFD).

As the non-magnetic intermediate layer 132, Pt, Pd, or ZnO can be used preferably. ZnO is thermally stable. In addition, the milling speed for ZnO during processing of the perpendicular magnetic recording layer 13 is fast as compared to a general compound such as oxide, nitride, and carbide, and hence pattern processing thereof is easy.

The film thickness of the non-magnetic intermediate layer 132 is preferred to be in the range of 0.5 nm to 2 nm. When it is less than 0.5 nm, the aforementioned dispersion suppressing effect is difficult to be exhibited. When it is more than 2 nm, the exchange interaction which operates between the hard magnetic recording layer and the soft magnetic recording layer decreases significantly, and hence it is not preferable.

When the non-magnetic intermediate layer 132 is deposited by the sputtering method, a lower pressure of the rare gas (sputtering gas) such as Ar facilitates formation of a finer film and increases the SFD reduction effect, and hence it is preferable. Specifically, the sputtering gas pressure range of 0.1 Pa to 2 Pa is preferable.

As constituent materials of the soft magnetic recording layer 133, Co, Fe, Co—Pt alloy, and Fe—Pt alloy can be exemplified. Among them, the Co—Pt alloy and Fe—Pt alloy are more preferable. The Co—Pt alloy and Fe—Pt alloy contain Pt, and hence have high oxygen resistance. Thus, they can suppress deterioration of characteristics due to oxidization when a mask material, which will be described later, is patterned by RIE or ion milling using O₂. These alloys are preferred to have an FCC structure instead of the aforementioned ordered alloy and have a Pt composition in the range of 40 atomic % to 70 atomic %.

These alloys are substantially the same in composition as the constituent materials of the above-described hard magnetic recording layer 131, and thus easily become an ordered alloy by heating the substrate 11 during milling processing, which will be described later. It has been found that, when the soft magnetic recording layer 133 is deposited under a low gas pressure by the sputtering method, it is possible to suppress becoming the ordered alloy due to heating. Specifically, it was found by experiment that deposition in the range of 0.1 Pa to 2 Pa is preferable.

Although the total thickness of the perpendicular magnetic recording layer 13 is determined by a requested value from the system, generally, one thinner than 20 nm is preferable, and one thinner than 5 nm is more preferable. When the total thickness of the perpendicular magnetic recording layer 13 exceeds 20 nm, dot pattern processing is difficult. When the total thickness of the perpendicular magnetic recording layer 13 is thinner than 0.5 nm, signal strength during reproduction decreases significantly.

As already described, the non-magnetic base layer 12 is formed as necessary prior to formation of the perpendicular magnetic recording layer 13.

The non-magnetic base layer 12 controls crystal orientation of the perpendicular magnetic recording layer 13 (hard magnetic recording layer 131), and moreover has a function to facilitate becoming an ordered alloy.

As a specific material, when the perpendicular magnetic recording layer 13 (hard magnetic recording layer 131) has the L1₀ structure, it is possible to preferably use Pt, Pd, Ir, MgO, or the like which is oriented in (100) plane. Particularly, when the material of the non-magnetic base layer 12 is Pt, Pd, Ir or an alloy of them, the flatness of the perpendicular magnetic recording layer 13 increases, and the above-described formation of the milling mask 21 becomes easy, which is preferable.

When Pt, Pd, Ir or an alloy of them is used as the material of the non-magnetic base layer 12, the temperatures of the substrate 11 during both the above-described deposition and ion milling are preferred to be in the range lower than or equal to 400° C. for carrying out these processes. When they exceed 400° C., solid dissolving of the non-magnetic base layer 12 and the perpendicular magnetic recording layer 13 occurs, which deteriorates the magnetic characteristics. When the perpendicular magnetic recording layer 13 has the L1₁ structure, Ru or an alloy thereof oriented in (0001) plane can be used preferably.

The film thickness of the non-magnetic base layer 12 is preferred to be in the range of 1 nm to 20 nm, and is more preferred to be in the range of 3 nm to 10 nm. When the film thickness is less than 1 nm, the above-described orientation dispersion reduction effect is difficult to be exhibited significantly. When the film thickness exceeds 20 nm, a magnetic space between a soft magnetic base layer 18 which will be described later and the perpendicular magnetic recording layer 13 becomes too wide, and a recording characteristic (writability) decreases.

### (2) Formation of the Milling Mask 21 on the Perpendicular Magnetic Recording Layer 13 (Step S12, See FIG. 3B)

A mask material is deposited on the perpendicular magnetic recording layer 13 so as to form a projecting and recessed pattern (minute shape array structure) (transfer).

### (a) Deposition of the Mask Material

As the mask material, for example, C or a compound thereof is deposited on the perpendicular magnetic recording layer 13.

### (b) Application of a Resist Material, Transfer of Pattern

A resist material such as a light-curing resin is applied on the surface of the mask material. Then, a stamper on which a dot pattern is transferred is used to transfer the projecting and recessed pattern (minute shape array structure) on the resist material by a nano-imprint method.

Instead of the nano-imprint method, self-assembly of diblock polymer may be used. On the mask material surface, a diblock polymer such as a PS (Polystyrene)-PMMA (polymethyl methacrylate) is applied, and self-assembly of the diblock polymer is made to occur, thereby forming the pattern.

### (c) Patterning the Mask Material

The projecting and recessed pattern is transferred onto the mask material with the resist material having the projecting and recessed pattern being a mask. For example, reactive ion milling (RIE) is performed with oxygen ions on the mask material.

### (3) Milling the Perpendicular Magnetic Recording Layer 13 (Step S13, See FIG. 3C and FIG. 3D)

The perpendicular magnetic recording layer 13 is etched by Ar ion milling. Thereafter, the SOG milling mask 21 is removed from the perpendicular magnetic recording layer 13 by the reactive ion milling (RIE) with a CF₄ gas.

Using the milling mask 21 having the minute shape array structure, the perpendicular magnetic recording layer 13 is processed into the minute shape array structure.

The perpendicular magnetic recording layer 13 is pattern-processed by the ion milling. Specifically, by making ions I be incident on the perpendicular magnetic recording layer 13, the perpendicular magnetic recording layer 13 is etched. As ion species for the milling, rare gases such as Ar, Xe, He, Ne, and the like as well as hydrogen can be used preferably. As a method of the ion milling, ion irradiation by an ion gun as well as inductively coupled plasma (ICP) etching, RIE, inverse sputtering using a sputtering apparatus, or the like can be used preferably.

Here, the temperatures of the substrate 11 are set to be 250° C. to 500° C. during the pattern processing step of the perpendicular magnetic recording layer 13 by the ion milling.

In the ion milling step, as a result of giving energy higher than the coupling energy with surrounding atoms by collision of ions against magnetic alloy atoms, magnetic alloy elements are milled. This energy is at 1600° C. or higher when converted into temperatures. At this time, alloy elements in side wall portions of dots, which are adjacent to the milled atoms, are heated locally to temperatures near this temperature. The ordered alloy used in this embodiment has a stable disordered phase at high temperatures. For example, in the case of an FePt alloy, the L1₀ ordered phase transforms into a disordered phase at 1300° C. or higher.

When the substrate 11 is ion milled without being heated, the side wall portions of dots transformed into a disordered phase are cooled rapidly to be close to the room temperature after the milling, and the disordered phase is retained. That is, by the energy of collision of ions during the ion milling, the disordered phase is formed locally in the ordered alloy material. The magnetic anisotropy energy density Kᵤ of the disordered phase in this alloy is much lower than that of the ordered phase. Thus, when the disordered phase is formed, the average magnetic anisotropy energy density Kᵤ of magnetic dots decreases, and the thermal fluctuation resistance of the patterned medium decreases.

In contrast, when the substrate 11 is heated during the ion milling processing, the side wall portions of dots transformed into the disordered phase are kept at certain high temperatures after the milling, and are able to re-transform into an ordered phase. At this time, the temperature of the substrate 11 is set to a temperature under which the ordered phase can exist stably and dispersion of atoms is possible. As a result, the side wall portion transformed into the disordered phase during the milling can be allowed to re-transform into the ordered phase, thereby enabling suppressing formation of the disordered phase due to the milling step.

Specifically, when the temperature of the substrate 11 is in the range of 250° C. to 500° C., the disordered phase formation due to the milling step can be suppressed effectively. Temperatures being in the range of 300° C. to 400° C. are more preferable. When the temperature of the substrate 11 is lower than 250° C., the dispersion of alloy atoms is difficult to occur, and hence it is not preferable. On the other hand, when the temperature of the substrate 11 exceeds 500° C., solid dissolving occurs between the mask material and the hard magnetic crystal grains, and hence it is not preferable.

On the other hand, a method that allows re-ordering of a disordered phase by post annealing after the milling processing is also conceivable. However, by this method, atoms in the disordered phase portion are cooled once to be close to the room temperature after the milling, and thus the atoms strongly couple to each other in a disordered phase state. In order to cause atom dispersion in the strongly coupled disordered phase and allow re-transformation into the ordered phase, high temperatures above 500° C. are needed.

In contrast, when the substrate 11 is ion milled in a state of being heated as in this embodiment, the alloy atoms reach the temperature of the substrate 11 from a state of being thermally excited sufficiently after the milling. Thus, the coupling among atoms does not become strong during the ion milling, and the dispersion occurs under relatively low heating temperatures, thereby allowing the re-transformation into the ordered phase to occur.

During the ion milling step, the temperature of the substrate 11 has to be maintained. When the temperature of the substrate 11 decreases during the ion milling, the disordered phase formation suppression effect becomes insufficient. Therefore, it is preferable to start heating the substrate 11 until just before starting the ion milling.

Moreover, during the processing of the milling mask 21 by RIE ((c) in step S12), turning of the magnetic alloy to a disordered phase may become a problem. Accordingly, also during the processing step of the milling mask 21, it is more preferable to heat the substrate 11, similarly to the ion milling of the perpendicular magnetic recording layer 13.

However, unlike the ion milling step of the perpendicular magnetic recording layer 13, in the milling mask 21 processing step, the milling ions can give thermal energy to the magnetic alloy elements only just before the milling mask 21 processing step is finished, and thus it is not necessary to maintain the heating temperature throughout the entire milling mask 21 processing step. Particularly, when the milling mask 21 material is formed of two or more layers, the substrate 11 may be heated just in the processing step of a layer in contact with the perpendicular magnetic recording layer 13.

### (4) Formation of the Protective Layer 14 and the Lubricant Layer 15 (Steps S14, S15, FIG. 3E, See FIG. 1)

The protective layer 14 and the lubricant layer 15 can be provided on the perpendicular magnetic recording layer 13. Examples of the protective layer 14 include C, diamond-like carbon (DLC), SiNx, SiOx, and CNx. As a lubricant forming the lubricant layer 15, for example, a perfluoropolyether (PFPE) can be used.

### Modification Example 1

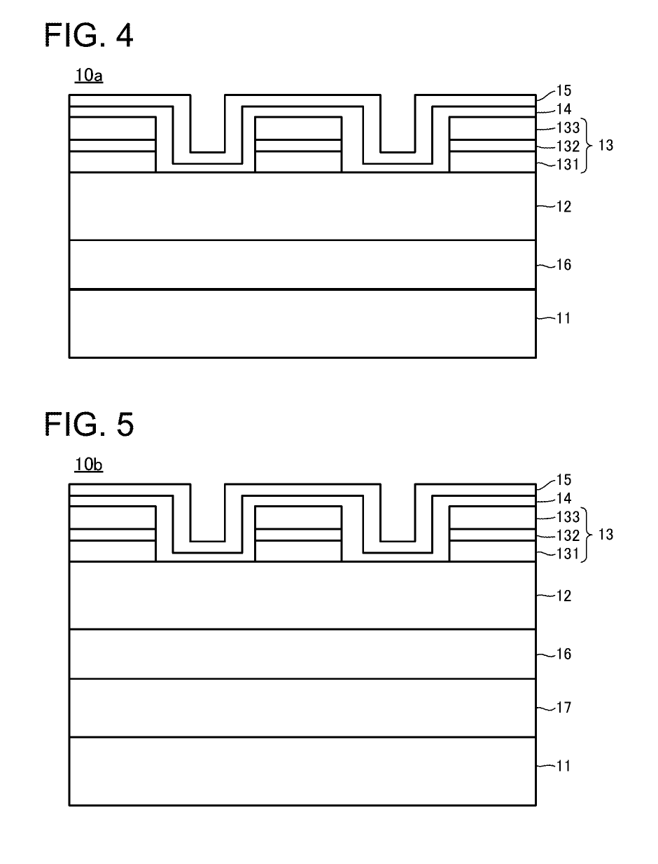

FIG. 4 is a cross-sectional view representing a patterned medium 10a according to Modification Example 1. In the patterned medium 10a, a second non-magnetic base layer 16, the non-magnetic base layer 12, the perpendicular magnetic recording layer 13, the protective layer 14, and the lubricant layer 15 are layered sequentially on the substrate 11. The perpendicular magnetic recording layer 13 has a minute shape array structure, in which the hard magnetic recording layer 131, the non-magnetic intermediate layer 132, and the soft magnetic recording layer 133 are layered sequentially and patterned.

When the perpendicular magnetic recording layer 13 has the L1₀ structure, for the purpose of improving crystal orientation in the non-magnetic base layer 12, the second non-magnetic base layer 16 can be provided between the non-magnetic base layer 12 and the substrate 11. Specifically, a Cr or Cr alloy oriented in (100) plane can be used. As the Cr alloy, a Cr—Ru alloy or Cr—Ti alloy can be used preferably.

The film thickness of the second non-magnetic base layer 16 is preferred to be in the range of 1 nm to 20 nm, and is more preferred to be in the range of 5 nm to 10 nm. When the film thickness is less than 1 nm, the above-described orientation dispersion reduction effect is difficult to be exhibited. When the film thickness exceeds 20 nm, a magnetic space between a soft magnetic base layer 18 which will be described later and the perpendicular magnetic recording layer 13 becomes too wide, and a recording characteristic (writability) decreases.

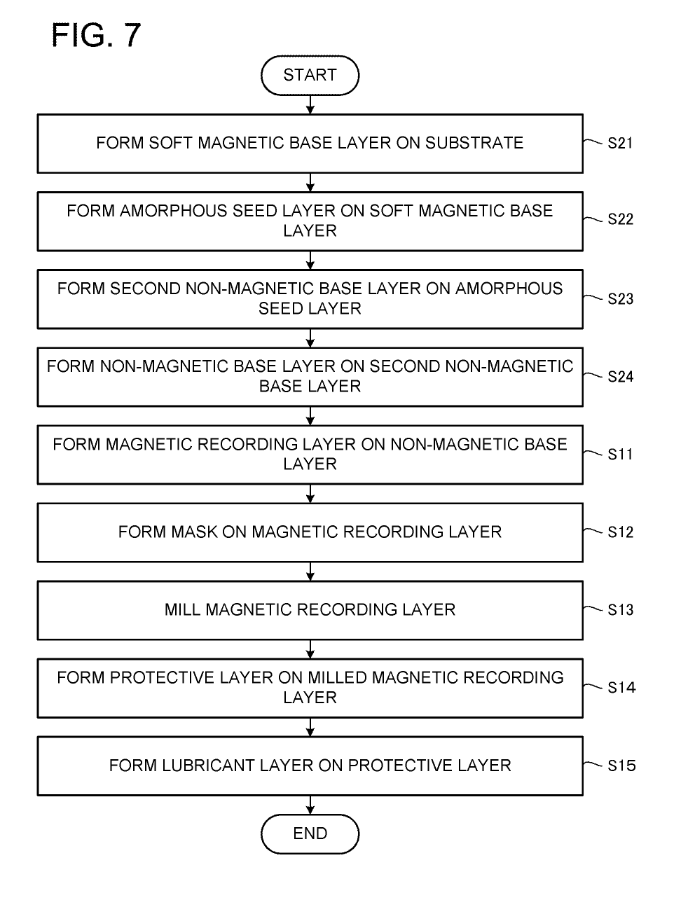

The patterned medium 10a can be made through steps S24, S11 to S15 in FIG. 7.

### Modification Example 2

FIG. 5 is a cross-sectional view representing a patterned medium 10b according to Modification Example 2. In the patterned medium 10b, an amorphous seed layer 17, the second non-magnetic base layer 16, the non-magnetic base layer 12, the perpendicular magnetic recording layer 13, the protective layer 14, and the lubricant layer 15 are layered sequentially on the substrate 11. The perpendicular magnetic recording layer 13 has a minute shape array structure, in which the hard magnetic recording layer 131, the non-magnetic intermediate layer 132, and the soft magnetic recording layer 133 are layered sequentially and patterned.

When the amorphous seed layer 17 formed of an amorphous alloy containing Ni is disposed between the second non-magnetic base layer 16 and the substrate 11, orientation dispersion in the (100) plane of the non-magnetic base layer 12 improves, and hence it is preferable.

The amorphousness mentioned here does not necessarily mean to be completely amorphous, like glass, and may refer to a film in a state that microcrystals having a grain diameter of 2 nm or less are randomly oriented locally.

As such an alloy containing Ni, for example, an alloy such as Ni—Nb alloy, Ni—Ta alloy, Ni—Zr alloy, Ni—W alloy, Ni—Mo alloy, or Ni—V alloy is used preferably.

The Ni content in these alloys is preferred to be in the range of 20 to 70 atomic percent because they easily become amorphous in this range. Moreover, in some cases, it may be preferable to expose the surface of the seed layer in an atmosphere containing oxygen.

The film thickness of the amorphous seed layer 17 is preferred to be in the range of 1 nm to 20 nm, and is more preferred to be in the range of 5 nm to 10 nm. When the film thickness is less than 1 nm, the above-described orientation dispersion reduction effect is difficult to be exhibited. When the film thickness exceeds 20 nm, a magnetic space between a soft magnetic base layer 18 which will be described later and the perpendicular magnetic recording layer 13 becomes too wide, and a recording characteristic (writability) decreases.

The patterned medium 10b can be made through steps S23, S24, S11 to S15 in FIG. 7.

### Modification Example 3

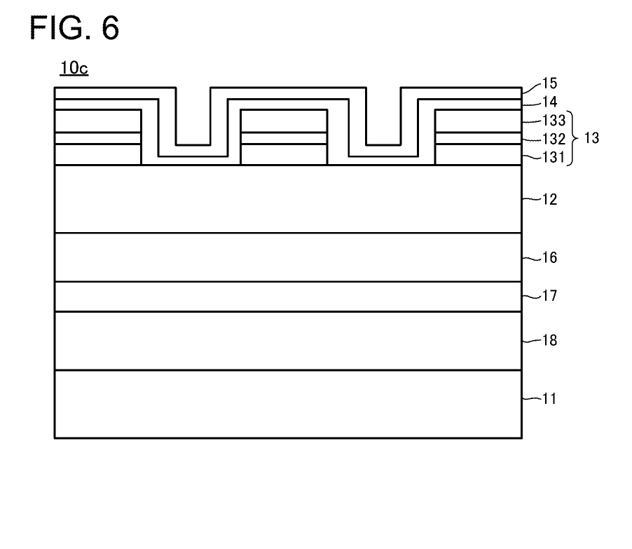

FIG. 6 is a cross-sectional view representing a patterned medium 10c according to Modification Example 3. In the patterned medium 10c, a soft magnetic base layer 18, the amorphous seed layer 17, the second non-magnetic base layer 16, the non-magnetic base layer 12, the perpendicular magnetic recording layer 13, the protective layer 14, and the lubricant layer 15 are layered sequentially on the substrate 11. The perpendicular magnetic recording layer 13 has a minute shape array structure, in which the hard magnetic recording layer 131, the non-magnetic intermediate layer 132, and the soft magnetic recording layer 133 are layered sequentially and patterned.

By providing the soft magnetic base layer 18 with high magnetic permeability between the non-magnetic base layer 12 and the substrate 11, what is called a vertical two-layer medium is formed. In this vertical two-layer medium, the soft magnetic base layer 18 bears part of the function of the magnetic head. That is, the soft magnetic base layer 18 passes in a horizontal direction a recording magnetic field from a magnetic head, for example a single-pole magnetic head, for magnetizing the perpendicular magnetic recording layer 13 and allows it to flow back to the magnetic head side. The soft magnetic base layer 18 applies a steep and sufficient perpendicular magnetic field to the recording layer of magnetic field, and hence is able to serve the role of improving recording and reproduction efficiency.

Examples of constituent materials of the soft magnetic base layer 18 include CoZrNb, CoB, CoTaZr, FeSiAl, FeTaC, CoTaC, NiFe, Fe, FeCoB, FeCoN, FeTaN, CoIr, and the like.

The soft magnetic base layer 18 may be a multi-layer having two or more layers. In this case, the materials, compositions, and film thicknesses of respective layers may be different. Further, the soft magnetic base layer 18 may have a three-layer structure in which these two layers are stacked sandwiching an Ru layer which is thin. The film thickness of the soft magnetic base layer 18 is adjusted appropriately according to the balance between an overwrite (OW) characteristic and a signal-noise ratio (SNR).

As a method of depositing each layer, it is possible to use a vacuum evaporation method, a sputtering method, a chemical vapor deposition method, or a laser abrasion method. As the sputtering method, it is possible to use a single-target sputtering method using a composite target and a multi-target simultaneous sputtering method using targets of respective substances can be used.

The patterned medium 10c can be made through steps in FIG. 7.

### Second Embodiment

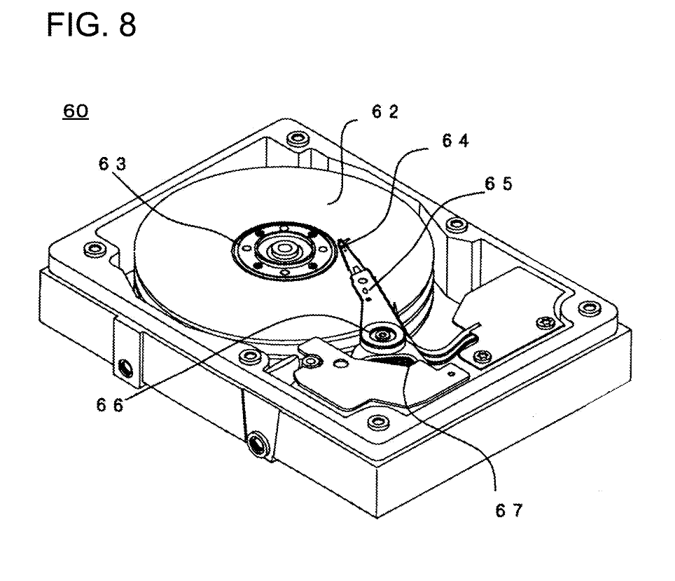

FIG. 8 is a view illustrating a magnetic recording and reproducing device 60 according to a second embodiment.

The magnetic recording and reproducing device 60 is a device of the type using a rotary actuator. A recording medium disk 62 is mounted on a spindle motor 63, and is rotated by a motor (not illustrated) responding to a control signal from a driving device control unit (not illustrated). The magnetic recording and reproducing device 60 according to this embodiment may be one having a plurality of recording medium disks 62.

When the recording medium disk 62 rotates, the pressing pressure by a suspension 64 and a pressure generated on a medium opposing face (also called ABS) of a head slider balance out. As a result, the medium opposing face of the head slider is retained with a predetermined floating amount from the surface of the recording medium disk 62.

The suspension 64 is connected to one end of an actuator arm 65 having a bobbin part or the like which holds a driving coil (not illustrated). On the other end of the actuator arm 65, a voice coil motor 67 which is one type of a linear motor is provided. The voice coil motor 67 can be constituted of the driving coil (not illustrated) wound on the bobbin part of the actuator arm 65 and a magnetic circuit formed of a permanent magnet and an opposing yoke which are disposed opposing each other across this coil.

The actuator arm 65 is retained by a ball bearing (not illustrated) provided at two, upper and lower positions of a bearing unit 66, and can be freely rotated and slid by the voice coil motor 67. Consequently, the magnetic recording head can be moved to an arbitrary position of the recording medium disk 62.

### Example

Hereinafter, examples will be described specifically.

### Example 1

A non-magnetic glass substrate 11 (TS-10SX made by OHARA) having a 2.5 inch hard disk shape was introduced into a vacuum chamber of a sputtering apparatus of c-3010 type made by ANELVA Corporation.

After the inside of the vacuum chamber of the sputtering apparatus was exhausted to 1×10⁻⁵ Pa or lower, 20 nm of a Co-5% Zr-5% Nb alloy as the soft magnetic base layer 18 and 5 nm of Ni-40% Ta as the amorphous seed layer 17 were deposited sequentially. Thereafter, an Ar-1% O₂ gas was introduced so that the in-chamber pressure becomes 5×10⁻² Pa, and the surface of the amorphous seed layer 17 was exposed for five seconds in this Ar/O₂ atmosphere. Thereafter, 5 nm of Cr as the second non-magnetic base layer 16 and 10 nm of Pt as the non-magnetic base layer 12 were deposited.

Thereafter, the substrate 11 was heated to 300° C. using an infrared lamp heater. The heating time was 13 seconds. After the heating, 5 nm of Fe-50% Pt was deposited as the perpendicular magnetic recording layer 13 (hard magnetic recording layer 131). Moreover, the substrate 11 was cooled to the room temperature, and thereafter 20 nm of C and 3 nm of Si were deposited sequentially as the milling mask 21.

The Ar pressure during deposition was 0.7 Pa for all of the soft magnetic base layer 18, the amorphous seed layer 17, the second non-magnetic base layer 16, the non-magnetic intermediate layer 132, the soft magnetic recording layer 133, the non-magnetic base layer 12, and the milling mask 21, and the Ar pressure during deposition of the hard magnetic recording layer 131 (FePt) was 8 Pa. As the sputtering target, a Co-5% Zr-5% Nb target, an Ni-40% Ta target, a Cr target, a Pt target, an Fe-50% Pt target, a C target, and an Si target each having a diameter of 164 mm were used, and deposition was performed by a DC sputtering method. Input power to each target was 100 W for all of them. The distance between a target and the substrate 11 was 50 mm.

Besides that, ones in which the perpendicular magnetic recording layer 13 is Co-50% Pt or Fe-50% Pd were made in the same manner.

Besides that, one in which the non-magnetic base layer 12 is replaced with Ru was made in the following manner.

After the inside of the vacuum chamber of the sputtering apparatus was exhausted to 1×10⁻⁵ Pa or lower, 20 nm of a Co-5% Zr-5% Nb alloy as the soft magnetic base layer 18, 5 nm of Pd as the second non-magnetic base layer 16, and 20 nm of Ru as the non-magnetic base layer 12 were deposited sequentially. Thereafter, the substrate 11 was heated to 300° C. using an infrared lamp heater. The heating time was 13 seconds. After the heating, 5 nm of Co-50% Pt was deposited as the perpendicular magnetic recording layer 13 (hard magnetic recording layer 131). Moreover, the substrate 11 was cooled to the room temperature, and thereafter 20 nm of C and 3 nm of Si were deposited sequentially as the milling mask 21.

After the deposition, the perpendicular magnetic recording layer 13 was patterned to have dots in the following manner. The substrate 11 was taken out of the sputtering apparatus, and a PS (polystyrene)-PMMA (polymethyl methacrylate) diblock polymer solved in an organic solvent was applied with a spin coating method, which was then subjected to a heat treatment at 200° C.

Thereafter, the PMMA which was phase separated was removed by RIE using a CF₄ gas. Thereafter, the milling mask 21 constituted of C in a dot shape was formed by RIE using an O₂ gas. At this time, the substrate 11 is not heated. That is, the temperature T1 during formation of the milling mask 21 (during milling of the milling mask 21) is the room temperature (RT).

Thereafter, the substrate 11 was heated to 300° C. using the infrared lamp heater. In a state that this temperature is maintained, the perpendicular magnetic recording layer 13 was etched by Ar ion milling using an ion gun. Specifically, the temperature T2 during milling of the perpendicular magnetic recording layer 13 is 300° C. An acceleration voltage for Ar ions was 600 V, and a milling time was 8 s (seconds). As a result, a bit pattern array with 17 nm pitch was made.

### Comparative Example 1

As a comparative example, the patterned medium was made in the following manner without heating the substrate 11 during ion milling. Other than that the substrate 11 was not heated during ion milling, the patterned medium was made in the same manner as in Comparative Example 1. Specifically, the temperature T1 during formation of the milling mask 21 (during milling of the milling mask 21) and the temperature T2 during milling of the perpendicular magnetic recording layer 13 were both the room temperature (RT).

### Comparative Example 2

As a comparative example, the patterned medium was made in the following manner, in which the substrate 11 was not heated during ion milling and post-annealing was performed after the ion milling. The ion milling was performed in the same manner as in Comparative Example 1. Specifically, the temperature T1 during formation of the milling mask 21 (during milling of the milling mask 21) and the temperature T2 during milling of the perpendicular magnetic recording layer 13 were both the room temperature (RT).

Thereafter, using an electric furnace, the substrate 11 was heated to 300° C. in a vacuum, and the patterned medium was made. The heating time was 30 minutes, and the temperature was maintained for 60 minutes.

With respect to each obtained patterned medium, an X-ray diffractometer X'pert-MRD made by Philips was used to generate Cu—Kα rays under the condition of 45 kV acceleration voltage and 40 mA filament electric current, and the crystal structure and the crystal plane orientation were evaluated by a θ-2θ method.

H_{c} in a film perpendicular direction to the perpendicular magnetic recording layer 13 of each patterned medium was evaluated using a laser light source with a wavelength of 408 nm by a polar Kerr effect evaluation apparatus BH-M800UV-HD-10 made by NEOARK Corporation, under the condition of 20 kOe maximum applied magnetic field and 133 Oe/s magnetic field sweep rate.

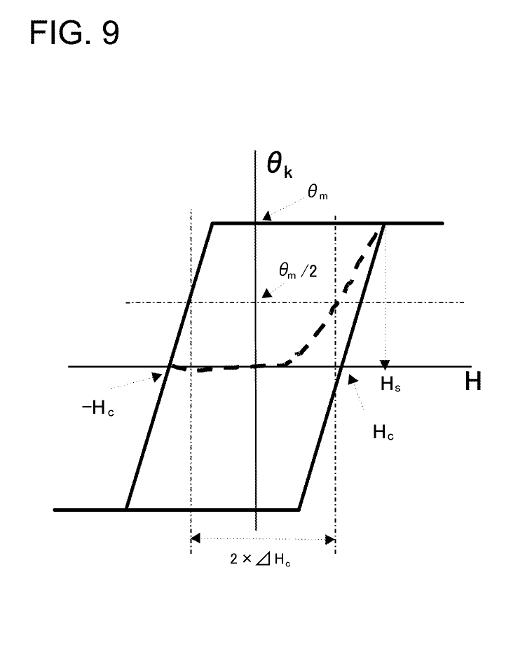

The switching field dispersion (SFD) of each patterned medium was evaluated by a ΔH_{c}/H_{c} method using the polar Kerr effect evaluation apparatus. FIG. 9 illustrates the ΔH_{c} and an evaluation method thereof. That is, after a hysteresis loop (bold solid line) was obtained through the above-described manner, an applied magnetic field was folded back at the point of —H_{c} on the hysteresis loop to reach Hₛ, thereby obtaining a minor loop (bold dotted line). A difference between a magnetic field as θₛ/2 on the minor loop and a magnetic field in the second quadrant of the hysteresis loop is defined as 2ΔH_{c} and is standardized by H_{c}, thereby obtaining ΔHc/Hc.

The switching field dispersion (SFD) was calculated by using the following equation.

SFD=ΔH_{c}/1.38H_{c}

Further, the above-described apparatus was used to evaluate thermal fluctuation resistance index β of each patterned medium in the following manner. Note that the larger the value of β, the higher the thermal fluctuation resistance. β can be obtained using the following equation from magnetic field application time (t) dependence H_{cr}(t) of residual coercive force.

H_{cr}(t)=H₀(1−(1n(f₀·t)/β)^{0.5})

Here, H₀ is coercive force at time zero, f₀ is frequency factor (10⁹ seconds), and β=KᵤV/k_{B}T, where Kᵤ is magnetic anisotropy energy density, k_{B} is Boltzmann coefficient, and T is absolute temperature. β and H₀ can be obtained by fitting with respect to various values of t.

To use results of normal Kerr measurement for this, measurement was performed while varying a sweep rate t_{swp}, and obtained coercive force H_{c}(t_{swp}) was converted into residual coercive force H_{cr}(t). This conversion was performed by solving an equation disclosed in a document (M. P. Sharrock: IEEE Trans. Magn. 35 p. 4414 (1999)) in a self-consistent manner.

The minute structure of each layer of each perpendicular magnetic recording medium was evaluated by using a TEM with acceleration voltage 400 kV. The dot shape of each patterned medium was evaluated using a scanning electron microscope (SEM).

As a result of the XRD evaluation, it was found that in all the media using Cr and Pt as the non-magnetic base layer 12, the hard magnetic crystal grains have the L1₀ structure. On the other hand, it was found that the hard magnetic crystal grains for which Ru was used as the non-magnetic base layer 16 have the L1₁ structure. It was found that in all the media, crystal grains of the hard magnetic recording layer 131 are also oriented in c plane.

As a result of SEM observation, it was found that magnetic dots of all the patterned media have an ordered array structure with dot pitch of about 17 nm.

Table 1 illustrates the coercive force H_{c} obtained by the Kerr measurement, the switching field dispersion SFD, the thermal fluctuation resistance index β, and the degree of order S of the hard magnetic recording layer obtained by the XRD evaluation.

TABLE 1

| | | | | Perpendicular | | | | |
|---|---|---|---|---|---|---|---|---|
| | Temperature | Temperature | Non-magnetic | magnetic recording | H_{c} | SFD | | |
| | T1 [° C.] | T2 [° C.] | base layer | layer | [kOe] | [%] | β | S |
| Example 1 | R.T. | 300 | Cr/Pt | L1₀-FePt | 21.2 | 10.3 | 299 | 0.82 |
| Example 1 | R.T. | 300 | Cr/Pt | L1₀-CoPt | 19.9 | 8.9 | 260 | 0.79 |
| Example 1 | R.T. | 300 | Cr/Pt | L1₀-FePd | 19.1 | 8.8 | 240 | 0.85 |
| Example 1 | R.T. | 300 | Pd/Ru | L1₁-CoPt | 18.5 | 7.5 | 220 | 0.77 |
| Comparative | R.T. | R.T. | Cr/Pt | L1₀-FePt | 13.8 | 20.1 | 110 | 0.53 |
| Example 1 | | (non-post | | | | | | |
| | | annealed) | | | | | | |
| Comparative | R.T. | R.T. | Cr/Pt | L1₀-FePt | 14.1 | 19.8 | 116 | 0.54 |
| Example 2 | | (post | | | | | | |
| | | annealed) | | | | | | |

In the patterned medium of Example 1, the coercive force H_{c}, the switching field dispersion SFD, the thermal fluctuation resistance index β, and the degree of order S improved as compared to the media of Comparative Examples 1, 2. This is conceivably because, by heating the substrate 11 during the ion milling, disordered phase formation in the hard magnetic crystal grains was suppressed and the degree of order S improved, and consequently the magnetic anisotropy energy density Kᵤ increased.

In the patterned medium of Example 2, no significant improvement was seen in any of the coercive force H_{c}, the switching field dispersion SFD, the thermal fluctuation resistance index β, and the degree of order S as compared to the patterned medium of Comparative Example 1. This is conceivably because, as compared to when the substrate 11 was heated during the milling, when the substrate 11 was heated (annealed) after the milling the hard magnetic crystals are difficult to be reordered, and the degree of order S did not improve largely.

As described above, it was found that the coercive force H_{c}, the switching field dispersion SFD, the thermal fluctuation resistance index β, and the degree of order S improve by employing a hard magnetic alloy material including the first element (Fe or Co) and the second element (Pt or Pd) and having the L1₀ or L1₁ structure as the hard magnetic recording layer 131, and milling it at 300° C.

### Example 2

Patterned media for which the temperature T2 of the substrate 11 during the ion milling processing was varied in the range of 200° C. to 600° C. were made in the following manner.

Except that the temperature T2 of the substrate 11 was varied in the range of 200° C. to 600° C. during the ion milling processing, the patterned media were made in the same manner as in Example 1.

As a result of the XRD evaluation, it was found that in all the media using Cr and Pt as the non-magnetic base layer 12, the hard magnetic crystal grains have the L1₀ structure. On the other hand, it was found that the hard magnetic crystal grains for which Ru was used as the non-magnetic base layer 12 have the L1₁ structure. It was found that in all the media, crystal grains of the hard magnetic recording layer 131 are also oriented in c plane.

As a result of SEM observation, it was found that magnetic dots of all the patterned media for which the temperature T2 of the substrate 11 during the ion milling is lower than or equal to 500° C. have an ordered array structure with dot pitch of about 17 nm. On the other hand, in the patterned media for which the temperature T2 of the substrate 11 is above 500° C., aggregation of part of dots was observed.

Table 2 illustrates the coercive force H_{c}, the switching field dispersion SFD, the thermal fluctuation resistance index β, and the degree of order S.

TABLE 2

| | | | Perpendicular | | | | |
|---|---|---|---|---|---|---|---|
| | Temperature | Temperature | magnetic | H_{c} | SFD | | |
| | T1 [° C.] | T2 [° C.] | recording layer | [kOe] | [%] | β | S |
| Comparative | R.T. | R.T. | L1₀-FePt | 13.8 | 20.1 | 110 | 0.53 |
| Example 1 | | | | | | | |
| Example 2 | R.T. | 200 | L1₀-FePt | 13.9 | 20.0 | 112 | 0.53 |
| Example 2 | R.T. | 250 | L1₀-FePt | 17.9 | 15.1 | 200 | 0.70 |
| Example 1 | R.T. | 300 | L1₀-FePt | 21.2 | 10.3 | 299 | 0.82 |
| Example 2 | R.T. | 350 | L1₀-FePt | 21.3 | 9.2 | 302 | 0.85 |
| Example 2 | R.T. | 400 | L1₀-FePt | 21.5 | 8.9 | 305 | 0.87 |
| Example 2 | R.T. | 500 | L1₀-FePt | 18.0 | 14.2 | 230 | 0.80 |
| Example 2 | R.T. | 600 | L1₀-FePt | 12.1 | 25.3 | 102 | 0.75 |

As long as the temperature T2 of the substrate 11 is in the range of 250° C. to 500° C., the coercive force H_{c}, the switching field dispersion SFD, the thermal fluctuation resistance index β, and the degree of order S improved. This is conceivably because, by heating the substrate 11 during the ion milling, disordered phase formation in the hard magnetic crystal grains was suppressed and the degree of order S improved, and consequently the magnetic anisotropy energy density Kᵤ increased. It can be seen that the temperature T2 of the substrate 11 being in the range of 300° C. to 400° C. is more preferable.

On the other hand, when the temperature T2 of the substrate 11 exceeds 500° C., the coercive force H_{c} and the thermal fluctuation resistance index β deteriorate, which is not preferable. This is conceivably because aggregation of dots or solid dissolving between the non-magnetic base layer 12 and the hard magnetic crystal grains occurred, and the magnetic characteristics deteriorated.

### Example 3

Patterned media whose substrate 11 was heated during processing of the milling mask 21 were made in the following manner. The media were made in the same manner as in Example 1 except that the milling mask 21 having a dot shape formed of C was formed by RIE using an O₂ gas in a state that the substrate 11 was heated.

As a result of the XRD evaluation, it was found that in all the media using Cr and Pt as the non-magnetic base layer 12, the hard magnetic crystal grains have the L1₀ structure. On the other hand, it was found that the hard magnetic crystal grains for which Ru was used as the non-magnetic base layer 12 have the L1₁ structure. It was found that in all the media, crystal grains of the hard magnetic recording layer 131 are also oriented in c plane.

As a result of SEM observation, it was found that magnetic dots of all the patterned media have an ordered array structure with dot pitch of about 17 nm.

Table 3 illustrates the coercive force H_{c}, the switching field dispersion SFD, the thermal fluctuation resistance index β, and the degree of order S.

TABLE 3

| | | | Perpendicular | | | | |
|---|---|---|---|---|---|---|---|
| | | | magnetic | | | | |
| | Temperature | Temperature | recording | H_{c} | SFD | | |
| | T1 [° C.] | T2 [° C.] | layer | [kOe] | [%] | β | S |
| Example 1 | R.T. | 300 | L1₀-FePt | 21.2 | 10.3 | 299 | 0.82 |
| Example 3 | 200 | 300 | L1₀-FePt | 21.1 | 10.2 | 300 | 0.83 |
| Example 3 | 250 | 300 | L1₀-FePt | 22.0 | 9.6 | 350 | 0.90 |
| Example 3 | 300 | 300 | L1₀-FePt | 23.1 | 9.0 | 400 | 0.96 |
| Example 3 | 350 | 300 | L1₀-FePt | 23.1 | 8.9 | 403 | 0.96 |
| Example 3 | 400 | 300 | L1₀-FePt | 23.4 | 9.2 | 405 | 0.97 |
| Example 3 | 500 | 300 | L1₀-FePt | 21.9 | 11.2 | 330 | 0.86 |
| Example 3 | 600 | 300 | L1₀-FePt | 16.1 | 20.3 | 181 | 0.72 |

As long as the temperature T1 of the substrate 11 during formation of the milling mask 21 is in the range of 250° C. to 500° C., the coercive force H_{c}, the switching field dispersion SFD, the thermal fluctuation resistance index β, and the degree of order S further improved. This is conceivably because, by heating the substrate 11 during the ion milling, disordered phase formation in the hard magnetic crystal grains was suppressed and the degree of order improved, and consequently the magnetic anisotropy energy density Kᵤ increased. Further, it can be seen that the temperature T1 of the substrate 11 being in the range of 300° C. to 400° C. is more preferable.

On the other hand, when the temperature T1 of the substrate 11 during formation of the milling mask 21 exceeds 500° C., it was found that H_{c} and β deteriorate, which is not preferable. This is conceivably because solid dissolving between the non-magnetic base layer 12 and the hard magnetic crystal grains occurred, and the magnetic characteristics deteriorated.

### Example 4

Patterned media in which the perpendicular magnetic recording layer 13 has two layers of the hard magnetic recording layer 131 and the soft magnetic recording layer 133 were made in the following manner.

In the same manner as in Example 1, the hard magnetic recording layer 131 was deposited, and thereafter 1 nm of Co-50% Pt was deposited as the soft magnetic recording layer 133. The Ar pressure during deposition of the soft magnetic recording layer 133 was 0.7 Pa for all the media. Besides that, one for which the material of the soft magnetic recording layer 133 was changed to Fe-50% Pt, and one for which the Pt composition was varied were also made.

Thereafter, deposition of the milling mask material, formation (etching) of the milling mask 21, and milling of the perpendicular magnetic recording layer 13 were performed sequentially in the same manner as in Example 1.

As a result of the XRD evaluation, it was found that in all the media using Cr and Pt as the non-magnetic base layer 12, the hard magnetic crystal grains have the L1₀ structure. On the other hand, it was found that the hard magnetic crystal grains for which Ru was used as the non-magnetic base layer 12 have the L1₁ structure.

Further, it was found that the soft magnetic recording layer 133 of all the patterned media did not become an ordered alloy and had an fcc or hcp structure. It was found that in all the media, crystal grains of the hard magnetic recording layer 131 are also oriented in c plane.

As a result of SEM observation, it was found that magnetic dots of all the patterned media have an ordered array structure with dot pitch of about 17 nm.

Table 4 illustrates the coercive force H_{c}, the switching field dispersion SFD, the thermal fluctuation resistance index β, and the degree of order S.

TABLE 4

| | | Hard magnetic | Soft magnetic | | | | |
|---|---|---|---|---|---|---|---|
| | Temperature | recording | recording | H_{c} | SFD | | |
| | T2 [° C.] | layer | layer | [kOe] | [%] | β | S |
| Example 1 | 300 | L1₀-FePt | — | 21.2 | 10.3 | 299 | 0.82 |
| Example 4 | 300 | L1₀-FePt | hcp-Co | 20.9 | 10.8 | 300 | 0.82 |
| Example 4 | 300 | L1₀-FePt | hcp-Co—20% Pt | 20.0 | 10.5 | 300 | 0.82 |
| Example 4 | 300 | L1₀-FePt | fcc-Co—40% Pt | 17.0 | 9.0 | 299 | 0.82 |
| Example 4 | 300 | L1₀-FePt | fcc-Co—50% Pt | 17.5 | 8.8 | 300 | 0.82 |
| Example 4 | 300 | L1₀-FePt | fcc-Co—70% Pt | 18.0 | 8.5 | 300 | 0.82 |
| Example 4 | 300 | L1₀-FePt | fcc-Co—80% Pt | 20.1 | 10.6 | 300 | 0.82 |
| Example 4 | 300 | L1₀-FePt | fcc-Fe—60% Pt | 16.5 | 9.0 | 299 | 0.82 |

It was found that using a Co—Pt alloy which has an fcc structure and in which the Pt composition is in the range of 40 to 70 atomic % as the soft magnetic recording layer 133 is preferable. The coercive force H_{c} can be reduced while maintaining the thermal fluctuation resistance index β. When the Pt composition is less than 40%, no significant result was observed. This is conceivably because part of Co atoms in the soft magnetic recording layer oxidized by oxygen RIE in the milling mask 21 forming step. Further, when the Pt composition exceeds 70%, no significant result was observed. This is conceivably because the saturation magnetization amount in the soft magnetic recording layer decreased.

Similar tendencies were recognized in the case where the soft magnetic recording layer 133 is the Fe—Pt alloy. Specifically, using the Fe—Pt alloy which has an fcc structure and in which the Pt composition is in the range of 40 to 70 atomic % as the soft magnetic recording layer 133 is preferable.

Note that in Table 4, since the material of the hard magnetic recording layer 131 and the temperature T2 during the milling are the same, the thermal fluctuation resistance index β and the degree of order S are substantially the same.

### Example 5

Patterned media in which the perpendicular magnetic recording layer 13 has three layers of the hard magnetic recording layer 131, the non-magnetic intermediate layer 132, and the soft magnetic recording layer 133 were made in the following manner.

The media were made in the same manner as in Example 4 except that Pt was deposited as the non-magnetic intermediate layer 132 between the hard magnetic recording layer 131 and the soft magnetic recording layer 133.

Ones using Pd or ZnO instead of Pt as the non-magnetic intermediate layer 132 were made similarly.

The Ar pressure during deposition of the non-magnetic intermediate layer 132 was 0.7 Pa for all the media, a Pt target, a Pd target, and a ZnO-2 wt. % Al₂O₃ target having a diameter of 164 mm were used as the sputtering target, and deposition was performed by a DC sputtering method. Input power to each target was 100 W watt for all of them.

As a result of the XRD evaluation, it was found that in all the media using Cr and Pt as the non-magnetic base layer 12, the hard magnetic crystal grains have the L1₀ structure. On the other hand, it was found that the hard magnetic crystal grains for which Ru was used as the non-magnetic base layer 12 have the L1₁ structure. Further, it was found that the soft magnetic recording layer 133 of all the patterned media did not become an ordered alloy and had an fcc structure. It was found that in all the media, crystal grains of the hard magnetic recording layer 131 are also oriented in c plane.

As a result of SEM observation, it was found that magnetic dots of all the patterned media have an ordered array structure with dot pitch of about 17 nm.

Table 5 illustrates the coercive force H_{c}, the switching field dispersion SFD, the thermal fluctuation resistance index β, and the degree of order S.

TABLE 5

| | | | | Soft | | | | |
|---|---|---|---|---|---|---|---|---|
| | | Hard magnetic | Non-magnetic | magnetic | | | | |
| | Temperature | recording | intermediate | recording | H_{c} | SFD | | |
| | T2 [° C.] | layer | layer | layer | [kOe] | [%] | β | S |
| Example 1 | 300 | L1₀-FePt | — | — | 21.2 | 10.3 | 299 | 0.82 |
| Example 4 | 300 | L1₀-FePt | — | fcc- | 17.5 | 8.8 | 300 | 0.82 |
| | | | | Co—50% Pt | | | | |
| Example 5 | 300 | L1₀-FePt | Pt (0.2 nm) | fcc- | 17.2 | 8.7 | 300 | 0.82 |
| | | | | Co—50% Pt | | | | |
| Example 5 | 300 | L1₀-FePt | Pt (0.5 nm) | fcc- | 15.2 | 7.2 | 300 | 0.82 |
| | | | | Co—50% Pt | | | | |
| Example 5 | 300 | L1₀-FePt | Pt (1 nm) | fcc- | 14.0 | 6.5 | 300 | 0.82 |
| | | | | Co—50% Pt | | | | |
| Example 5 | 300 | L1₀-FePt | Pt (2 nm) | fcc- | 15.3 | 6.8 | 300 | 0.82 |
| | | | | Co—50% Pt | | | | |
| Example 5 | 300 | L1₀-FePt | Pt (3 nm) | fcc- | 17.0 | 8.9 | 300 | 0.82 |
| | | | | Co—50% Pt | | | | |
| Example 5 | 300 | L1₀-FePt | Pd (1 nm) | fcc- | 13.7 | 7.4 | 300 | 0.82 |
| | | | | Co—50% Pt | | | | |
| Example 5 | 300 | L1₀-FePt | ZnO (1 nm) | fcc- | 15.8 | 6.2 | 300 | 0.82 |
| | | | | Co—50% Pt | | | | |

It was found that it is preferable to provide the non-magnetic intermediate layer 132 of Pt in the range of 0.5 nm to 2 nm between the hard magnetic recording layer 131 or the like and the soft magnetic recording layer 133. The coercive force H_{c} and the switching field dispersion SFD can be reduced while maintaining the thermal fluctuation resistance index β.

Similar tendencies were recognized in the case where the non-magnetic intermediate layer 132 is Pd or ZnO. That is, in the case where the non-magnetic intermediate layer 132 is Pd or ZnO, the film thickness is preferred to be in the range of 0.5 nm to 2 nm.

Note that in Table 5, since the material of the hard magnetic recording layer 131 and the temperature T2 during the milling are the same, the thermal fluctuation resistance index β and the degree of order S are substantially the same.

Although patterned media are described in the above-described embodiments, the techniques of the embodiments can also be applied to general recording media.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method for manufacturing a patterned medium, the method comprising:
forming a perpendicular magnetic recording layer on a substrate;
forming a mask on the perpendicular magnetic recording layer;
milling the perpendicular magnetic recording layer; and
depositing a protective layer on the perpendicular magnetic recording layer,
wherein the perpendicular magnetic recording layer includes a first element selected from Fe and Co and a second element selected from Pt and Pd, and has a hard magnetic alloy material having an L1₀ or L1₁ structure, and
wherein a temperature of the substrate during the milling is higher than or equal to 250° C. and lower than or equal to 500° C.

2. The manufacturing method of the patterned medium according to claim 1,
wherein the substrate includes a non-magnetic material.

3. The manufacturing method of the patterned medium according to claim 1,
wherein the formation of the mask comprises:
forming a mask material layer on the perpendicular magnetic recording layer; and
patterning the mask material layer by milling,
wherein a temperature of the substrate during the milling of the mask material layer is higher than or equal to 250° C. and lower than or equal to 500° C.

4. The manufacturing method of the patterned medium according to claim 1,
wherein the perpendicular magnetic recording layer includes:
a hard magnetic recording layer having the hard magnetic alloy material; and
a soft magnetic recording layer having a Co—Pt or Fe—Pt alloy having an fcc structure.

5. The manufacturing method of the patterned medium according to claim 4,
wherein the hard magnetic recording layer includes a Fe—Pt alloy, a Co—Pt alloy, or a Fe—Pd alloy.

6. The manufacturing method of the patterned medium according to claim 5,
wherein the hard magnetic recording layer further includes Cu, Zn, Zr, Cr, Ru, or Ir.

7. The manufacturing method of the patterned medium according to claim 4,
wherein the formation of the perpendicular magnetic recording layer includes forming the hard magnetic recording by sputtering.

8. The manufacturing method of the patterned medium according to claim 7,
wherein the sputtering is conducted in a rare gas of 4 Pa or more and 12 Pa or less.

9. The manufacturing method of the patterned medium according to claim 4,
wherein the soft magnetic recording layer includes Co, Fe, a Co—Pt alloy, or a Fe—Pt alloy.

10. The manufacturing method of the patterned medium according to claim 4,
wherein the soft magnetic recording layer is formed by sputtering in a rare gas of 0.1 Pa or more and 2 Pa or less.

11. The manufacturing method of the patterned medium according to claim 4,
wherein the soft magnetic recording layer includes 40 atomic % or more and 70 atomic % or less of Pt.

12. The manufacturing method of the patterned medium according to claim 4,
wherein the perpendicular magnetic recording layer further has a non-magnetic intermediate layer disposed between the hard magnetic recording layer and the soft magnetic recording layer and including Pt, Pd, or ZnO.

13. The manufacturing method of the patterned medium according to claim 12,
wherein a film thickness of the non-magnetic intermediate layer is more than or equal to 0.5 nm and less than or equal to 2 nm.

14. The manufacturing method of the patterned medium according to claim 1, further comprising:
forming a non-magnetic base layer on the substrate before the formation of the perpendicular magnetic recording layer.

15. The manufacturing method of the patterned medium according to claim 14,
wherein a film thickness of the non-magnetic base layer is 1 nm or more and 20 nm or less.

16. The manufacturing method of the patterned medium according to claim 14,
wherein the hard magnetic recording layer has an L1₁ structure and the non-magnetic intermediate layer includes Ru oriented in (0001) plane.

17. The manufacturing method of the patterned medium according to claim 14,
wherein the hard magnetic recording layer has L1₀ structure and the non-magnetic intermediate layer includes Pt, Pd, Ir, or MgO oriented in (100) plane.

18. The manufacturing method of the patterned medium according to claim 14, further comprising:
forming a second non-magnetic base layer on the substrate before the formation of the non-magnetic base layer.

19. The manufacturing method of the patterned medium according to claim 18, further comprising:
forming an amorphous seed layer on the substrate before the formation of the second non-magnetic base layer.

20. The manufacturing method of the patterned medium according to claim 19, further comprising:
forming a soft magnetic base layer on the substrate before the formation of the amorphous seed layer.
